(19) United States
(12) Patent Application Publication
(10) Pub. No.: US 2026/0163233 A1
(43) Pub. Date: Jun. 11, 2026

(54) DIELECTRIC RADOME, ANTENNA SYSTEMS AND METHODS OF MANUFACTURING

(71) Applicant: NORTHERN WAVES AB, Stockholm (SE)

(72) Inventors: Astrid ALGABA BRAZÁLEZ, Goteborg (SE); Oscar QUEVEDO-TERUEL, Stockholm (SE); Jose RICO, Stockholm (SE); Pilar CASTILLO TAPIA, Stockholm (SE); Nuria FLORES ESPINOSA, Stockholm (SE); Almudena TORONJO RUIZ, Stockholm (SE)

(21) Appl. No.: 19/412,652

(22) Filed: Dec. 8, 2025

(30) Foreign Application Priority Data
Dec. 9, 2024 (EP) 24218494.3

(51) Int. Cl. H01Q 1/40; H01Q 1/42

(52) U.S. Cl. CPC H01Q 1/405; H01Q 1/42

(57) ABSTRACT

The present disclosure relates to a radome for protecting an antenna assembly. The radome comprises a body made of dielectric material, wherein the body is configured to redirect at least a portion of waves emitted by the antenna assembly. The present disclosure further relates to antenna systems including such a radome, and to methods of manufacturing such radomes.

### CROSS-REFERENCE

The present application claims the benefit of and priority to European Patent Application No. 24218494.3 filed Dec. 9, 2024, which has been incorporated herein By Reference in its Entirety.

The present disclosure relates to antenna systems, and more particularly relates to radomes for such antenna systems. The present disclosure further relates to methods of manufacturing of such radomes.

### BACKGROUND

Advanced Antenna Systems (AAS) may be regarded as antenna systems that leverage sophisticated technologies to improve performance, efficiency, and adaptability in wireless communication. These AAS are widely used in modern cellular networks, including 5G, as well as in radar, satellite communications, and IoT applications.

AAS products operating beyond millimeter-wave frequencies require highly directional, wideband and steerable antennas. In addition, the use of higher operating frequencies results in shorter wavelengths, which can challenge conventional design and manufacturing, especially in the context of antenna arrays.

As modern terrestrial communication systems become more advanced and intricate, a key challenge to overcome is the reduction of grating lobes which transmit electromagnetic waves in unintended directions. These grating lobes can often lead to undesirable results such as interfering with non-terrestrial systems like satellites.

For instance, it has become the norm for antenna systems such as those which are used for mobile broadband, to use large sub-arrays in elevation to ensure the required equivalent isotropic radiated power (EIRP) is achieved. However, using sub-arrays with a large inter-element distance triggers the appearance of grating lobes which may point over the horizon and can interfere with airborne systems.

And while these sub-arrays can be integrated into current antenna products and offer fast and precise scanning capabilities, they do have limitations at high frequencies and when scanning towards extreme angles, which ultimately results in high scanning losses.

Dealing with very short wavelengths in arrays can result in prohibitive design dimensions in manufacturing to avoid grating lobes. Moreover, a key challenge for 5G and future terrestrial communication systems is to ensure service over a wide area while avoiding interference with non-terrestrial systems such as satellites. This includes avoiding unwanted emissions above the horizon.

Structurally, the antenna system can include a mounting structure (e.g. a post, tower, mast or platform), and a radome. A radome may be regarded as a structural, weatherproof enclosure that protects an antenna or antenna assembly while minimally interfering with its operation. Its main functions include those of physical protection (e.g. from wind, rain, snow, hail, UV radiation and debris), electromagnetic transparency, streamlining and temperature and environmental control. Radomes tend to be made of materials such as fiberglass or plastic that are transparent to radio waves and its shape is generally chosen so as not to interfere with signals emitted by the antenna or signals to be received by the antenna.

In order to solve the aforementioned problem of grating lobes, it has been attempted to use a movable plastic lens array arranged over the PCB of the Phased Antenna Array i.e. between the antenna array and the radome. The mechanism to suppress the grating lobes while achieving high gain in this case consists of electronically phase shifting the array factor toward a desired angle as well as introducing a mechanical displacement of the lenses so that the lens element pattern combined with the array factor results in a low grating lobe level while steering. While this solution can provide wideband performance and high broadside gain at the center frequency, it comes with significant limitations as well. One limitation is that the optimum reduction of the grating lobe level requires mechanically moving the plastic lenses with respect to the array, which adds complexity to the system. Another challenge is the applicability of this solution when wider steering capability is needed.

A further alternative that has been attempted is an electrically thin metasurface-based dome, as disclosed in D. Ramaccia et al., “Metasurface Dome for Above-the-Horizon Grating Lobes Reduction in 5G-NR Systems,” IEEE Antennas Wirel. Propag. Lett., vol. 21, no. 11, 2022, pp. 2176-80. This implementation consists of shifting the scanning range from the array in order to avoid grating lobes, and thereafter re-adjusting the propagation towards desired angles when applying the radome on top of the array. There is however a trade-off between insertion loss at broadside and grating lobe level reduction that is required. And while this concept has the advantage that it can be applied on top of already existing antenna products, it still requires an additional radome to protect the whole system from environmental conditions, thereby increasing the profile of the antenna system. Furthermore, domes with a metasurface tend to exhibit narrow bandwidth and do not facilitate broadband communications.

The present disclosure aims to at least partially resolve some of the aforementioned disadvantages. While the above problems have been illustrated referring to specific antenna systems, it should be understood that the solutions provided herein are applicable and can be used in a wide variety of antenna applications.

### SUMMARY

In an aspect of the present disclosure, a radome for protecting an antenna assembly is provided. The radome comprises a body made of dielectric material, wherein the body is configured to redirect at least a portion of waves emitted by the antenna assembly.

In accordance with this aspect, a radome is provided which is configured to provide the typical functions that a radome provides, in particular protection of the antenna from outside (weather) influences. The radome particularly may form (part of) the outer protective structure of the antenna system. The radome according to the present disclosure can be made of the typical dielectric materials used for radome manufacturing. However, the radome itself has been modified so that when waves emitted by the antenna interact with the radome, specific portions of the waves can be diverted. I.e. examples of the present disclosure seek a specific interaction between the signals emitted by the antenna and the radome whereas in the prior art, the radome is generally designed to be transparent for the signals.

With examples of such a solution, previously mentioned problems relating to e.g. grating lobes can be avoided by steering away the waves that would cause grating lobes. At the same time, no separate lens assembly as known from the prior art or other additional components are needed. This can reduce complexity and cost. Examples of the present disclosure can also easily be retrofitted to existing antenna systems, e.g. by substituting an existing radome with a new radome according to the present disclosure. Moreover, the profile of the antenna system can remain small in examples of the present disclosure.

In accordance with some examples, a shape of the radome is configured to redirect at least a portion of the waves. In these examples, the interaction of the waves may be modified depending on the scanning direction. The outer surfaces of the radome may be chosen so as to provide an incident angle with the incoming waves at which refraction occurs. Such surfaces aimed at causing refraction in a desired direction may be provided at an inner side of the radome or at an outer side of the radome.

In examples, matching layers may be used at the outside of the radome.

In some examples, the body of the radome incorporates one or more internal structures configured to redirect at least a portion of the waves. In these examples, within the body of the radome, specific structures are provided, which can redirect at least a portion of the waves. In a non-limiting example, such internal structures may be prisms or prism-like.

As used throughout the present disclosure, a prism is to be understood as having the shape of an optical prism or “refractive prism”. Such a shape is characterized as having flat outer surfaces that are designed to refract electromagnetic waves. Refraction occurs both upon incidence of the waves on the prism, and when the waves leave the prism.

A prism may be have a wedge-shape (such as illustrated in FIG. 2B), i.e. a three-sided prism with a triangular cross-section. A prism may also have a rotationally-symmetric shape with a trapezoidal cross-section (such as illustrated e.g. in FIG. 7), or have a trapezoidal straight constant cross-section (such as illustrated e.g. in FIG. 6).

The internal structures may be made of a first material and a surrounding portion of the radome may be made of a second material, which is different from the first material. The change of materials within the radome creates a boundary or interface between two different media. According to Snell's law, the ratio of the sines of angle of incidence and angle of refraction is equal to the refractive index of the second medium with regard to the first medium (i.e. the ratio of the refractive indices of the two media).

In some examples, the internal structures may be made of a first material with a first density, and a surrounding portion of the radome is made of the first material with a second density, which is different from the first density. As an alternative to a different material, the same material may be used but its density can be changed, which creates the same boundary/interface for the application of Snell's law. Both mentioned examples are specifically suitable for additive manufacturing.

In some examples, a matching layer between the internal structures and the surrounding portion of radomes may be included as well in order to reduce reflections when the waves propagate through the internal structures.

Each matching layer may provide a gradual transition between the dielectric constants of the materials at the interface (i.e. air-radome material or first-second material of the radome). Typically, in these examples, a matching layer may be provided having a thickness of λ/4, wherein lambda refers to the operational wavelength of the antenna assembly. The matching layer preferably has a refractive index corresponding to the square root of the refractive indexes of the adjacent materials. In some examples, two or more consecutive matching layers may be used.

In accordance with a further aspect, an antenna system is provided. The antenna system comprises an antenna assembly and a radome to protect the antenna assembly, wherein the radome may be devised in accordance with any of the examples provided herein. In some examples, the antenna assembly may be a phased antenna array, and the radome may be configured to reduce grating lobe levels. In other examples, the radome may be configured to improve gain of the antenna in a specific direction. By choosing suitable internal structures for the radome and/or by choosing specific cross-sections for the radome, a desired effect can be promoted.

In accordance with yet a further aspect, a base station for a mobile communication system is provided. The base station includes an antenna system according to the previous aspect. Base stations according to this aspect have specific advantages for frequencies of 20 GHz or more, e.g. High-band 5G communication systems at 24 GHz to 39 GHz.

In yet a further aspect, a method of manufacturing a radome according to any of the above-mentioned examples is provided. The method of manufacturing comprises additive manufacturing. Additive manufacturing provides flexibility in terms of the shapes of the radomes, that might be manufactured, but also importantly it allows variation of materials and/or densities (e.g. by changing infill percentages) for an internal structure of the radomes and/or for the creation of a matching layer. Suitable additive manufacturing techniques can be selected in accordance with circumstances, and in particular dependent on the material selected for the radome.

### BRIEF DESCRIPTION OF THE DRAWINGS

Non-limiting examples of the present disclosure will be described in the following, with reference to the appended drawings, in which:

FIG. 1 schematically illustrates a perspective view of one example of a radome assembly according to the prior art;

FIG. 2A schematically illustrates waves or a beam emitted by a phased array antenna:

FIG. 2B schematically illustrates an example of a dielectric prism redirecting waves or a beam emitted by a phased array antenna;

FIGS. 3A-3C schematically illustrates an example of a dielectric prism (radome body) redirecting waves or a beam emitted by a phased array antenna at frequencies of 27 GHz, 28.5 GHz and 30 GHz, respectively;

FIGS. 3D-3F illustrates a comparison of the performance of the phased antenna array in the presence and absence of the dielectric prism at frequencies of 27 GHz, 28.5 GHz and 30 GHz, respectively;

FIG. 4A schematically illustrates an example of a radome body redirecting an electric field radiated by a phased array antenna scanning at an alternative angle from the broadside direction;

FIG. 4B illustrates a comparison of the performance of the phased antenna array in the presence and absence of the dielectric radome;

FIG. 4C Illustrates a further example of a radome body;

FIG. 5 schematically illustrates an example of a radome incorporating an internal structure for redirecting at least a portion of the waves;

FIG. 6 schematically illustrates an example of an antenna system including a dielectric radome;

FIGS. 7A-7C schematically illustrate a second example of an antenna system including a dielectric radome; and

FIG. 8 schematically illustrates a method for developing a dielectric radome in accordance with the present disclosure.

### DETAILED DESCRIPTION

Reference now will be made in detail to embodiments of the present disclosure, one or more examples of which are illustrated in the drawings. Each example is provided by way of explanation only, not as a limitation. In fact, it will be apparent to those skilled in the art that various modifications and variations can be made in the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

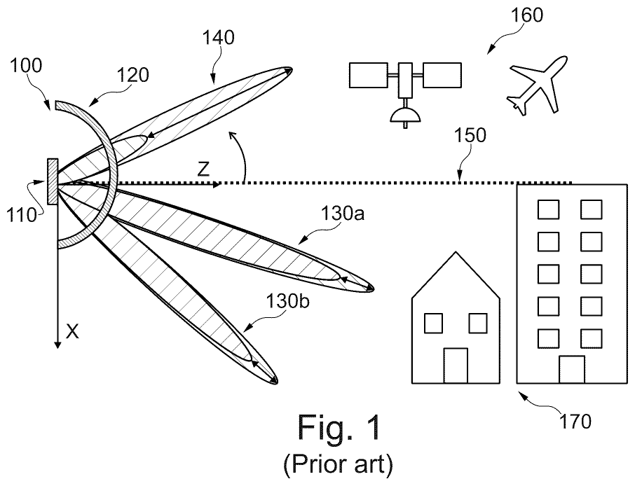

FIG. 1 illustrates a perspective view of one example of a conventional antenna system 100. The antenna system 100 depicted in this example may be a base station for e.g. a 5G telecommunication system. As shown, the antenna system 100 includes a phased array antenna 110 and a radome 120 partially enclosing the phased array antenna 110, i.e. the radome 120 protects the antenna array at least on the side of emission of antenna signals. At the opposite side of the antenna array a housing or support may be provided, e.g. a metallic housing or support.

A phased antenna array is a group of antennas arranged in a specific geometry, where the relative phase of the signal at each antenna element is adjusted to control the direction and shape of the overall radiation pattern. This allows the array to steer its main beam or nulls in different directions without physically moving the antennas.

The radome 120 provides a weatherproof enclosure for the phased array antenna 110 and shrouds the phased array antenna equipment from public view. In this example, the main beams 130a, 130b are directed towards residential buildings 170. An undesired emission (i.e., the grating lobe 140) is shown above the horizon line 150. Grating lobes 140 above the horizon line 150 can lead to interference with non-terrestrial systems 160, for example, satellites, airplanes and the like.

Grating lobes 140 are however hard to avoid at higher operating frequencies and relatively high inter-element distances in the array. Redirecting or avoiding the grating lobe 140 towards the main beam direction is desirable. In accordance with the present disclosure, radomes are proposed which combine their classical function of protecting the antenna array with the capability of redirecting radio beams. In a way, the radomes proposed combine the function of a radome and a dielectric lens into a single structure. By reducing grating lobes, inter-element distances in arrays might be increased allowing for improved cooling and simplification of the circuitry.

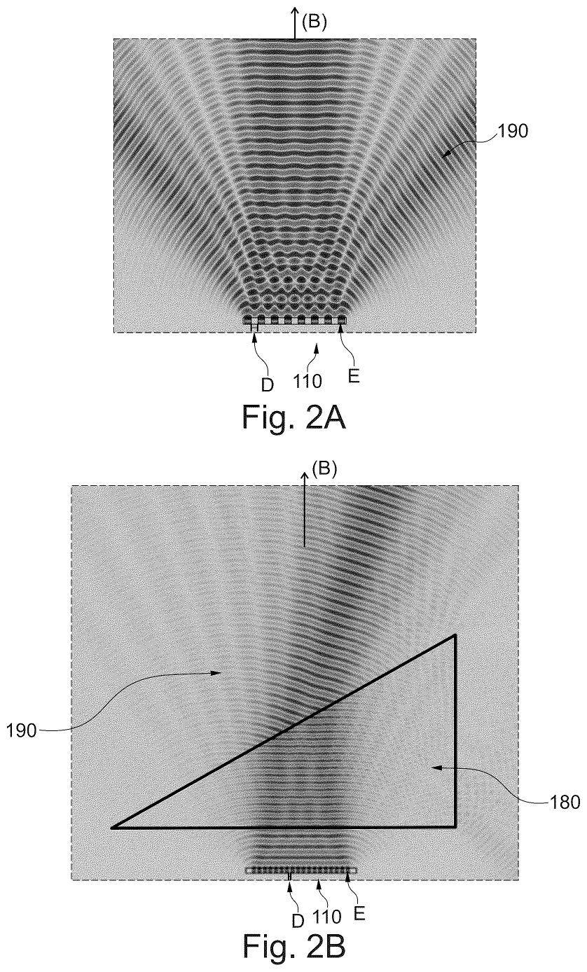

FIG. 2A illustrates an example of a phased array antenna 110 emitting a radio beam 190 pointing towards the broadside direction (B). The broadside direction may be understood as the direction of radiation (main lobe) of the radio waves that is perpendicular to the plane of the antenna arrays. This example shows a phased array antenna 110 of eight elements (E) with an inter-element distance (D) of 1.33 λ. Grating lobes generally occur at inter-element distances of 1 wavelength(λ), or more.

FIG. 2B illustrates an example of a dielectric prism 180 redirecting a radio beam 190 radiated by a phased array antenna 110 pointing towards the broadside direction (B). FIG. 2B merely serves to illustrate the basic principle underlying some of the examples of the present disclosure.

In the illustrated example, the phased array antenna 110 comprises 18 elements (E) with an inter-element distance (D) of 0.5 λ. The elements (E) can generate a plane wave. In this instance, the prism 180 is formed of dielectric material and has a substantially wedge shaped cross-section. Depending on the material properties, the prism 180 will be characterised by a specific refractive index and thereby also by a ratio of incident vs refraction angles. At the same time, the material of the prism will also define a range of angles in which a signal can refract. Using suitable refraction, a deviation angle can be obtained relative to a broadside direction (B) in order to achieve directivity enhancement.

The interaction of the waves at the edges of the prism 180, i.e. at the interface of the prism with the air is governed by Snell's law i.e. n_{¿}θ_{¿}=nₒᵤₜθₒᵤₜ, where nᵢₙ represents the refractive index of the incident medium, and nₒᵤₜ, the refractive index of the refracting medium, θᵢₙ angle of incidence, and θₒᵤₜ angle of refraction. Snell's law applies both at the inner side of the radome (the side facing the antenna) and at the outer side of the radome (the opposite side).

Thus, by choosing a suitable material, and by choosing suitable angles for the prism in accordance with circumstances, the rays from the antenna may be steered in one direction or another. The principle shown for the prism can be applied to a radome. I.e. an element such as the illustrated prism may be incorporated in a radome, or a cross-section of the radome may be selected such as to provide this effect.

Suitable materials which might be selected for the manufacture of the radome include e.g. glass-fibre reinforced polymers (e.g. glass-fibre reinforced polyester or epoxy), polyester, thermoplastic polycarbonate resin, or UHMWPE (“Ultra-high-molecular-weight polyethylene”), e.g. commercially available under the named Dyneema. Another option is a foam based on polymethacrylimide (PMI), such as Rohacell® 71 HF, commercially available from Evonik® and currently used for radome manufacture. Depending on the material chosen, the refractive index will be different, and thus the ratio of angles of incidence and of refraction will be different as well. Based on the material chosen, suitable angles for the prism (or other structure) may be selected to achieve redirection of at least a portion of the waves emitted by the antenna, both at the side facing the antenna and at the side facing away from the antenna.

Suitable materials may also be selected taking into account wideband applications. Herein, wideband refers to an antenna or system capable of operating efficiently over a broad range of frequencies. Further factors that may be taken into account include flame retardance, protection from UV radiation, thermal stability and corrosion resistance.

In the case illustrated in FIG. 2B, the simplest shape of a dielectric prism (right) was used, characterized by a material with a refractive index of n2=√2.2 and an angle α=30°. The deviation angle relative to broadside was δ=17.97°.

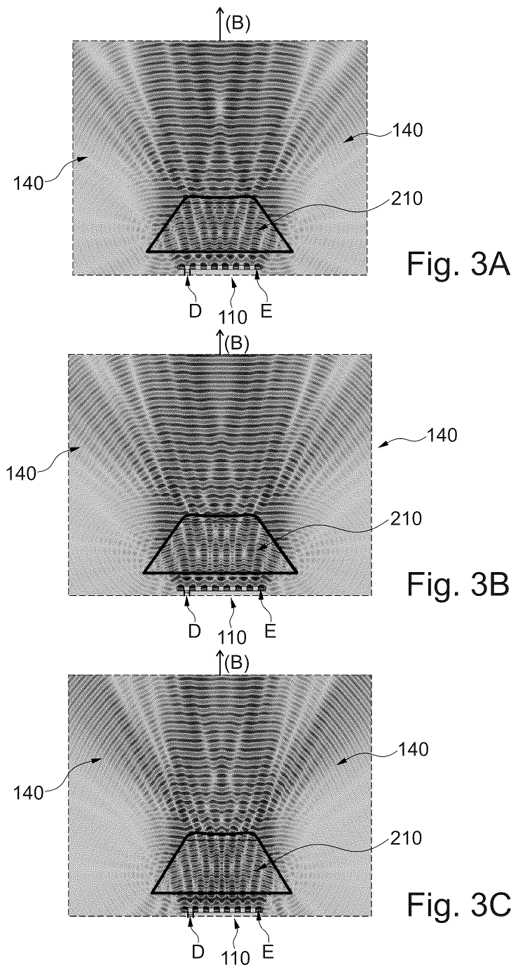

FIGS. 3A-3C illustrate an example of a dielectric radome 210 redirecting waves emitted by a phased array antenna 110 at frequencies of 27 GHz, 28.5 GHz and 30 GHz, respectively while pointing towards the broadside direction (B). The radome herein acts as a lens and may be regarded as comprising two dielectric prisms (each one aimed at reducing a grating lobe, respectively a grating lobe on the left-hand side, and a grating lobe on the right-hand side), which are connected to each other with the same dielectric material. These examples show a phased array antenna 110 of eight elements (E) with an inter-element distance (D) of 1.33 λ like in FIG. 2A. The scan direction is set to zero degrees i.e., a starting point in the broadside direction (B).

FIGS. 3A-3C depict refracting behaviour towards the main beam direction improves significantly and the shape and material of the prism 210 allows the grating lobes 140 to be steered towards the main beam direction based on the refractive index while maintaining the directivity of the main beam. In this particular case, the cross-section of the prism is substantially trapezoidal.

At a selected refractive index n=1.732, the dimensions of the dielectric radome (or “lens”) were selected as 79.08 mm in height and 187.96 mm in width. The lens in this example is positioned 7 mm above the array. Translating these measurements into terms of λ: the final height of the lens in this example is approximately 6.98 λ and its width is approximately 21.40 λ. The lens is positioned approximately 1.77 λ above the array.

As before, both at the side of incidence (the bottom of the prism facing the antenna 110), and where the electromagnetic waves leave the prism (at a top surface of the prism), refraction occurs. To this end, both the bottom surface and the upper surface comprise flat, straight sides.

The prism 210 may be rotationally symmetric. In other example, the prism 210 may extend axially with a constant cross-section.

FIGS. 3D-3F illustrate a comparison between the performance of the antenna system with a prior art “standard” radome (i.e. a radome that is practically transparent to the waves), and with a radome according to the examples of FIGS. 3A-3C respectively. In these figures, interrupted lines show the performance with a standard radome, whereas continuous lines indicate the performance with a radome acting as a lens to redirect emitted waves.

It can be seen in FIGS. 3D-3F , that grating lobes are significantly reduced when using the radome according to these examples and performance in the main direction is improved. The example of FIG. 3 illustrates that the desired objective of reducing grating lobes can be achieved at different frequencies, without the need to tailor a radome for each specific frequency.

When matching layers were added to these radomes, further improvements were found for Side Lobe Levels at frequencies of 27 GHz and 30 GHz, whereas the performance at 28.5 GHz remained substantially the same. It should be clear that these results may vary depending on the selected antenna assembly, its operating frequency, the shape and material of the radome etc.

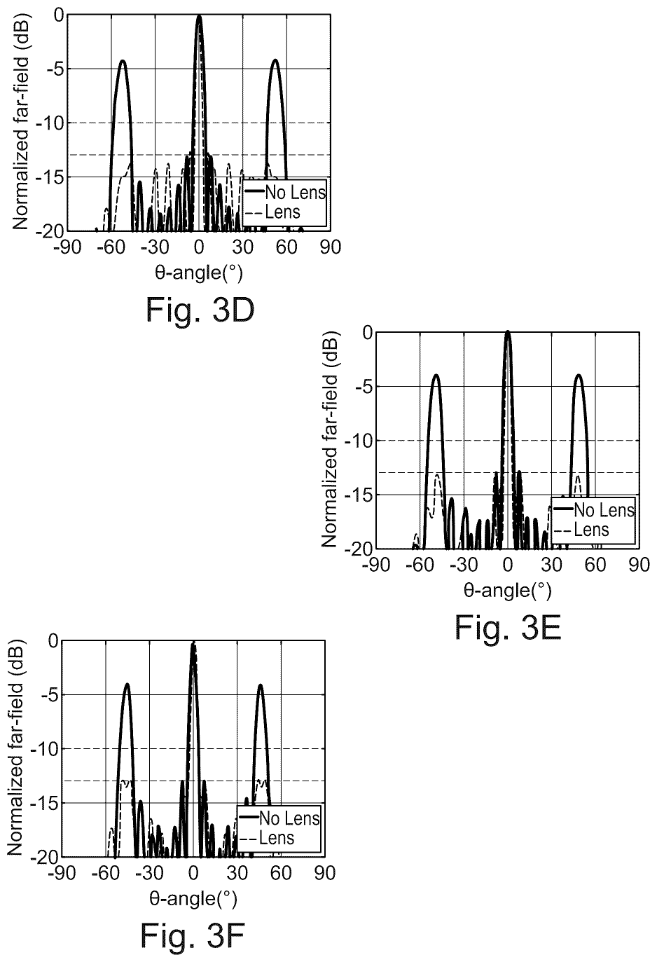

FIG. 4A illustrates an example of a further dielectric radome, functioning as a lens or “optical prism”, for redirecting waves emitted by a phased array antenna 110 scanning(S) at an alternative angle from the broadside direction (B). FIG. 4A shows a phased array antenna 110 of eight elements (E). The scanning angle (S) is at an angular distance of 10 degrees from the broadside direction (B).

The radome in this example, in a cross-sectional view, has a substantially flat upper surface, and side surfaces with a plurality of straight sections connected to each other. The plurality of straight sections extend at different angles, i.e. they are inclined with respect to each other. The lower straight sections are relatively close to perpendicular to the antenna array, whereas subsequent straight sections are inwardly inclined. In this particular example, the side surfaces in a cross-sectional view have three straight sections, but it should be clear that a different number of sections might be used. The bottom surface of the radome in this example has a substantially flat central area. The width or diameter (depending on the case) of the flat central area is slightly larger than a length of the antenna array. The sides of the bottom surface are slightly inclined with respect to the horizontal to take into account the different angles at which waves arrive at these portions of the radome.

Also in this case, the radome has substantially flat, straight outer surface section to ensure refraction as indicated in previous examples.

The chosen shape in this example is based on the material used for the radome, and on the selected scanning direction. It will be clear that suitable angles may vary in particular depending both on the selected scanning direction and on the material selected. The design of the radome in this example has a substantially straight central section, without refraction, in order not to influence the main beam.

Ultimately, by providing a linear upper surface 320 for the prism 310, the focus remains on redirecting radiation outside of the main beam, i.e., the grating lobes 140 as refraction is minimal at the linear upper surface 320.

While scanning(S) at an angular distance e.g., ±10 degrees or ±20 degrees away from a broadside direction (B), the prism 310 enables gain improvement and grating lobe reduction, as illustrated in FIG. 4B. In particular a significant grating lobe at an angle of about 60° from broadside is reduced or avoided using the depicted radome.

FIG. 4C shows a further example of a radome, which is similar to the example of FIG. 4A. FIG. 4C indicates for one specific example, suitable angles for the sections of the side surfaces, bottom surfaces etc. It is noted that in this example, compared to FIG. 4A, the bottom surface of the radome is further optimized, by subdividing the bottom surfaces in smaller straight sections at different inclinations. It will be clear that depending on the antenna assembly, the scanning angles, the objective of the redirecting and depending on the material chosen, the shape may vary. For this particular radome, a Phased Antenna Array according to the example of FIG. 3, operating at 28 GHz, scanning angle of +/−10° were assumed.

Theoretical further optimization in terms of redirecting waves may be obtained by including ever smaller sections at their own angles both for the side surfaces, and bottom surfaces. However, other factors such as an acceptable profile (height of the radome) and manufacturability may also be taken into account.

Both in the example of FIG. 4A and in the example of FIG. 4C, only a cross-section is shown. The radome may be rotationally symmetric but does not need to be.

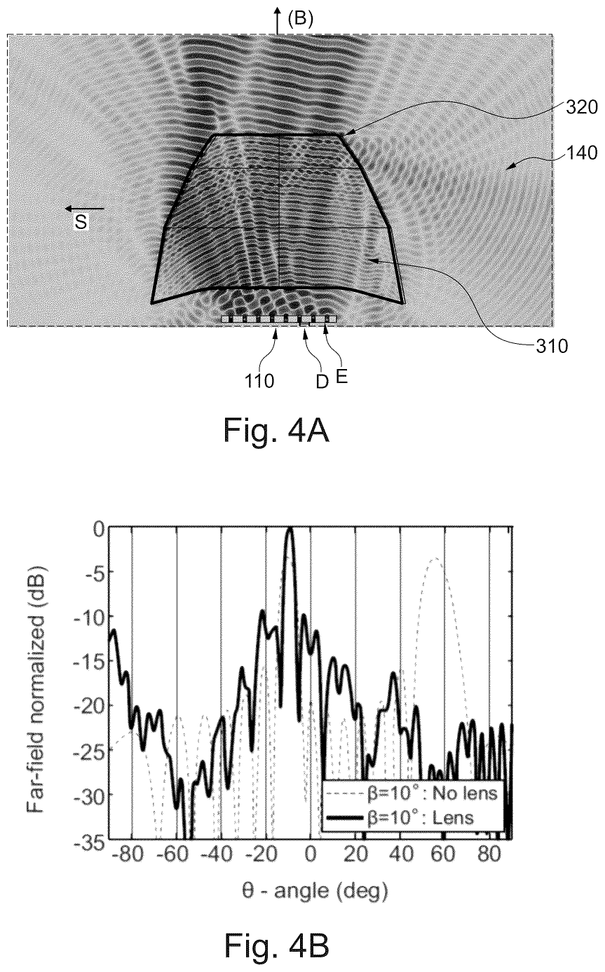

FIG. 5 illustrates an example of a radome 200 with a dielectric prism 210 at least partially enclosing or covering a phased array antenna 110. In this example, a distance between the radome 200 and the antenna assembly 110 may be 15-30 mm above the antenna assembly 110. In some examples, the distance between the radome 200 and the antenna assembly 110 is 1-3 times a wavelength of the antenna assembly 110.

The outer shape of the radome of FIG. 5 substantially corresponds to a standard radome designed so as not to interact with the emitted waves. However, in the radome of FIG. 5, an internal structure 210 has been provided inside the body of the radome which creates refraction. Refraction can take place both at the side of the internal structure facing the antenna array, and at the opposite side facing outwards.

The internal structure 210 may be made of a different material than the surrounding parts of the radome 200. The internal structure may also be made by a change in material density. The internal structure may be shaped like any of the other examples disclosed herein. In this example, the cross-section is again substantially trapezoidal.

Additive manufacturing techniques allow a multi-layer build-up which can tailor refraction as needed for any specific application. For example, matching layer(s), the internal structures and surrounding material of the radome can be manufactured in a single process in a layer by layer.

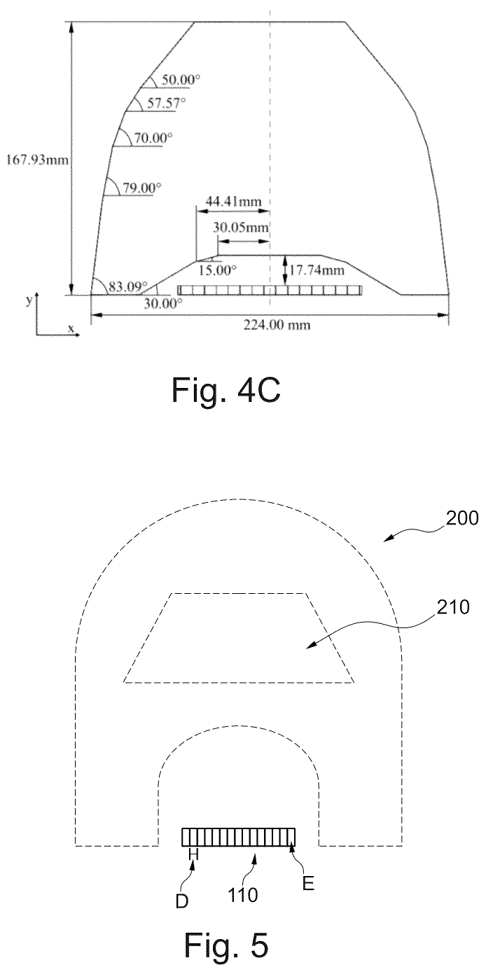

FIG. 6 illustrates a first embodiment of the dielectric radome 200 suitable for at least partially enclosing or covering a phased array antenna 110. The cross-sectional shape of the radome 200 in this example is based on the prism illustrated in FIGS. 3A-3C. It should be clear however, that other shapes might be chosen e.g. a cross-sectional shape corresponding to the example of FIG. 4A.

In the illustrated example, a cross-section for the radome 200 (and in particular the angles between the outer surface portions) is such that the refraction angle can be controlled accordingly. Viewed differently, a thickness or height of the radome varies in different scanning directions to achieve suitable refraction.

The redirection of the grating lobes 140 towards a desired scan direction can be achieved. The specific example of the radome of FIG. 6, which is essentially straight and has a constant cross-section might be extruded for mass production.

In some examples, a matching layer can be introduced after extrusion.

In other examples, the dielectric radome body can be produced by additive manufacturing. Additive manufacturing techniques simplifies the manufacture of e.g. multi-layer structures. Suitable additive manufacturing techniques include e.g. Fused Deposition Modeling (FDM)/Fused Filament Fabrication (FFF), stereolithography, selective laser sintering, direct ink writing. A selection may be made particularly based on the material used.

An outer layer of the radome may be configured as a matching layer aimed at reducing reflections when the waves propagate.

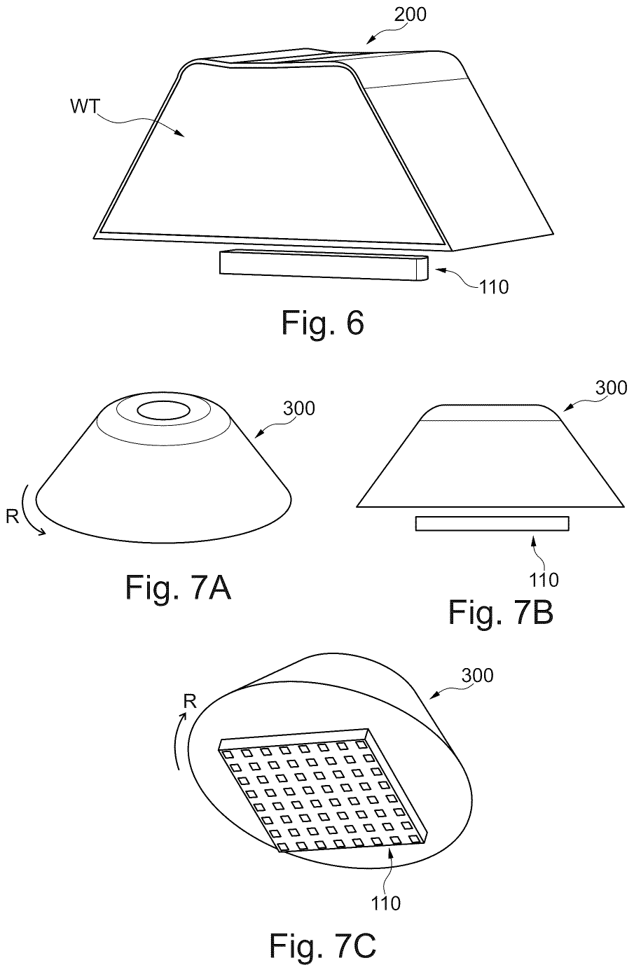

FIGS. 7A-7C illustrate a second example of a dielectric radome 300. FIG. 7A shows the dielectric radome 300 to be rotationally symmetric (R). This allows for scanning in two dimensions as the profile is symmetrical in both planes.

FIGS. 7B and 7C show the rotationally symmetric radome 300 arranged over a phased array antenna 110 at the side of emission. The phased antenna array 110 is seen to be arranged on a PCB. Like FIG. 6, this embodiment can be produced by additive manufacturing means. The compatibility with additive manufacturing processes not only enhances design flexibility and precision but also promotes efficient and cost-effective production.

For examples shown in FIG. 6 and FIGS. 7A to 7C, the dielectric material or materials selected for the radome body 200, 300 can provide environmental and mechanical protection for the phased array antenna 110. Through the proper choice of dielectric material properties, an additional protective layer or additional radome is not required.

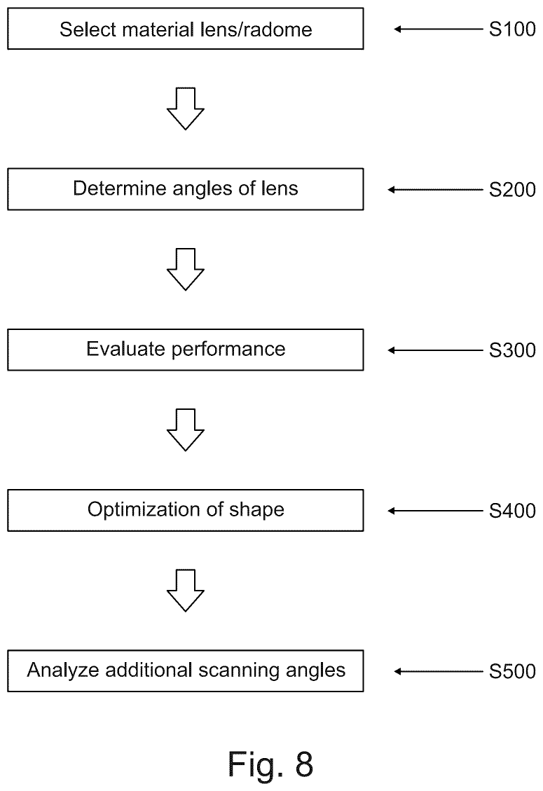

FIG. 8 provides a flowchart of an example for developing a radome according to the present disclosure.

The first step (S100) considers selecting a suitable material for the intended radome body or for the internal structure or “lens” within the radome body. Mechanical and environmental factors are considered when selecting the suitable material properties of the radome body in order to protect the antenna for which the radome is developed.

A second step S200 of this example comprises determining suitable angles of either the outer surface of the radome body or of the internal structure(s) in order to have the ability to deflect and manipulate at least a portion of the waves emitted from the antenna assembly. This is achieved by calculating the refractive index of the selected material(s) and by taking into account the characteristics of the waves, the objective of the redirecting of at least a portion of the waves, and the position of the radome body (or internal structure) with respect to the antenna.

A third step S300 is to evaluate the performance of the radome when deflecting at least a portion of the waves emitted from the phased array antenna in a desired direction. Performance evaluation factors include but not limited to, mitigation of grating lobes, enhancement of directivity, environmental protection and compatibility with a specific antenna assembly. A grating lobe level reduction percentage may be determined in some examples. Performance evaluation may include simulation but may also include rapid prototyping using additive manufacturing and carrying out experiments to evaluate the performance.

A fourth step S400 may be to optimise the solution. In this step, the radome body may be reduced in size and/or smoothing of its upper surface to control at least a portion of the waves emitted from the phased array antenna. This step may also include the simulation or testing of matching layers.

A fifth step S500 may be to analyse additional scanning angles e.g., ±10 degrees or ±20 degrees away from a broadside direction (B) and select desired material properties required to redirect at least a portion of the waves towards the desired scan direction i.e., towards the main beam.

Although not further illustrated it should be noted that radomes according to examples of the present disclosure may include widely varying cross-sections. In particular, internal structures may be provided inside the body of the radome which, due to e.g. a change in material density or a change in material, provide a further interface for refraction. Additive manufacturing techniques allow a multi-layer build-up which can tailor refraction as needed for any specific application.

Although the focus in the disclosure has been on phased antenna arrays and their use in base stations for e.g. 5G telecommunication systems, it should be clear that the benefits provided by radomes according to the present disclosure can also be obtained in other antenna applications.

This written description uses examples to disclose the present teaching, including the preferred embodiments, and also to enable any person skilled in the art to practice it, including making and using any product and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1. A radome for protecting an antenna assembly, the radome comprising:
a body made of dielectric material,
wherein the body is configured to redirect at least a portion of waves emitted by the antenna assembly and is configured to reduce grating lobe levels of the antenna assembly and to improve gain of the antenna assembly in a selected direction.

2. The radome of claim 1, wherein an outer shape of the radome is configured to redirect at least the portion of the waves.

3. The radome of claim 1, wherein the body incorporates one or more internal structures configured to redirect at least the portion of the waves.

4. The radome of claim 3, wherein the internal structures are made of a first material and a surrounding portion of the radome is made of a second material, which is different from the first material.

5. The radome of claim 3, wherein the internal structures are made of a first material with a first density, and a surrounding portion of the radome is made of the first material with a second density, which is different from the first density.

6. The radome of claim 3, wherein an outer shape of the radome is configured not to interact with the waves emitted by the antenna assembly.

7. The radome of claim 3, wherein the internal structures are shapes as prisms.

8. The radome of claim 1, further comprising a matching layer.

9. The radome of claim 1, wherein the dielectric material of the body comprises at least one of glass-fibre reinforced polymer, polyester, polycarbonate resin thermoplastic, polymethacrylimide, or UHMWPE.

10. A radome for protecting an antenna assembly, the radome comprising:
a body made of dielectric material, wherein
the body incorporates one or more internal structures configured to redirect at least a portion of waves emitted by the antenna assembly, wherein
the internal structures have a first refractive index and a surrounding portion of the body of the radome has a second refractive index.

11. The radome of claim 10, wherein the internal structures are made of a first material and the surrounding portion of the radome is made of a second material, which is different from the first material.

12. The radome of claim 10, wherein the internal structures are made of a first material with a first density, and the surrounding portion of the radome is made of the first material with a second density, which is different from the first density.

13. The radome of claim 10, wherein the internal structures are configured to redirect the portion of the waves emitted by the antenna assembly to reduce grating lobe levels of the antenna assembly and/or to improve gain of the antenna assembly in a specific selected direction.

14. The radome of claim 13, wherein an outer shape of the radome is configured not to interact with the waves emitted by the antenna assembly.

15. An antenna system comprising:
an antenna assembly; and
a radome configured to protect the antenna assembly, wherein
the radome comprises a body made of dielectric material, and a matching layer, wherein
the antenna assembly is configured to emit electromagnetic waves, the electromagnetic waves including a main beam and on or more grating lobes, and wherein
the body is configured to redirect at least a portion of the electromagnetic waves emitted by the antenna assembly to reduce grating lobe levels of the antenna assembly.

16. The antenna system according to claim 15, wherein the body of the radome is configured to improve gain of the main beam.

17. The antenna system according to claim 15, the body incorporates one or more internal structures configured to redirect at least the portion of the electromagnetic waves, wherein
the internal structures have a first refractive index and a surrounding portion of the body of the radome has a second refractive index.

18. The antenna system according to claim 15, wherein the antenna assembly is a phased antenna array.

19. The antenna system of claim 15, wherein a distance between the radome and the antenna assembly is 15-30 mm, or wherein a distance between the radome and the antenna assembly is 1-3 times a wavelength of the antenna assembly.

20. The antenna system of claim 15, wherein the antenna assembly is configured to operate at a frequency of 20 GHz or more.
